(19) United States
(12) Patent Application Publication
(10) Pub. No.: US 2025/0135628 A1
(43) Pub. Date: May 1, 2025

(54) TRANSPORT BOX, STACK ARRANGEMENT, TRANSPORT ARRANGEMENT, MOTOR VEHICLE AND METHOD

(71) Applicant: Festool GmbH, Wendlingen (DE)

(72) Inventors: Philipp EISENMANN, Bissingen (DE); Sibylle RAPP, Eislingen (DE)

(21) Appl. No.: 18/835,309

(22) PCT Filed: Feb. 2, 2023
(86) PCT No.: PCT/EP2023/052557

§ 371 Date: Aug. 1, 2024

(30) Foreign Application Priority Data
Feb. 3, 2022 (DE) 10 2022 201 164.3

(51) Int. Cl. B25H 3/02

(52) U.S. Cl. CPC B25H 3/021

(57) ABSTRACT

A transport box having an interior for accommodating goods to be transported and a wall structure which provides a horizontally oriented transport-box upper face and a horizontally oriented transport-box lower face. The transport box includes a coupling interface for detachable, vertical coupling, with an upper system box which can be placed onto the transport-box upper face, and with a lower system box which can be positioned underneath the transport-box lower face. The transport box has an access opening to the interior, which access opening is located on a vertically oriented transport-box peripheral face. The transport box has a cover structure which is attached to the wall structure and which closes the access opening in a closed position; and the cover structure is movable to an open position without changes to the coupling interface and/or without movement of the transport-box upper face and/or the transport-box lower face.

The invention relates to a transport box with an interior for accommodating a transport item, in particular a tool, as well as with a wall structure which provides a horizontally aligned transport box upper side and a horizontally aligned transport box lower side, wherein the transport box comprises a coupling interface for the releasable, vertically tension-proof coupling to an upper system box which can be placed onto the transport box upper side and to a lower system box which can be positioned below the transport box lower side, in order with the upper system box and the lower system box to form a vertical stack.

An object of the invention lies in providing a transport box which is easy to handle.

The object is achieved by a transport box according to claim 1. The transport box comprises an access opening to the interior, said access opening being arranged on a vertically aligned transport box peripheral side. The transport box comprises a cover structure which is attached to the wall structure and which in a closure position closes the access opening. The cover structure can be brought into an open position, in which the cover structure releases the access opening to the interior, without a change of the coupling interface and/or without a movement of the transport box upper side and/or of the transport box lower side.

What is meant by a change of the coupling interface in particular is an actuation of the coupling interface, in particular of a coupling section of the coupling interface, and/or a movement of the coupling interface, in particular of a coupling section of the coupling interface. What is meant by a movement (in particular of the transport box upper side and/or the transport box lower side) in particular is a repositioning for example a rotation and/or a translation.

On account of the described design of the transport box, in a state in which the transport box together with system boxes forms a vertical stack, in particular it is possible to open the access opening without one or more system boxes having to be moved for this.

Advantageous further developments are the subject-matter of the dependent claims.

The invention further relates to a stack arrangement, comprising the transport box, the upper system box and the lower system box, wherein the upper system box is placed upon the transport box upper side and the transport box via the coupling interface is coupled to the upper system box in a releasable and vertically tension-proof manner, and wherein the transport box with its transport box lower side is placed onto the lower system box and the transport box via the coupling interface is coupled to the lower system box in a releasable and vertically tension-proof manner, and wherein the cover structure can be brought into the open position without for this moving the upper system box and/or the lower system box.

The invention further relates to a transport arrangement comprising the transport box as well as an electrical tool, in particular a long-neck grinder, which is arranged in the transport box and which via the access opening can be removed from the transport box in the open position of the cover structure.

The invention further relates to a motor vehicle comprising a storage space, in which a vehicle stowage device is arranged, on which vehicle stowage device the transport box, the stack arrangement or the transport arrangement is releasably fastened.

The invention further relates to a method for operating the transport box, comprising the step: bringing the cover structure into the open position without changing the coupling interface and/or moving the transport box upper side and/or transport box lower side.

Further exemplary details as well as exemplary embodiments are explained hereinafter with reference to the figures. Herein are shown:

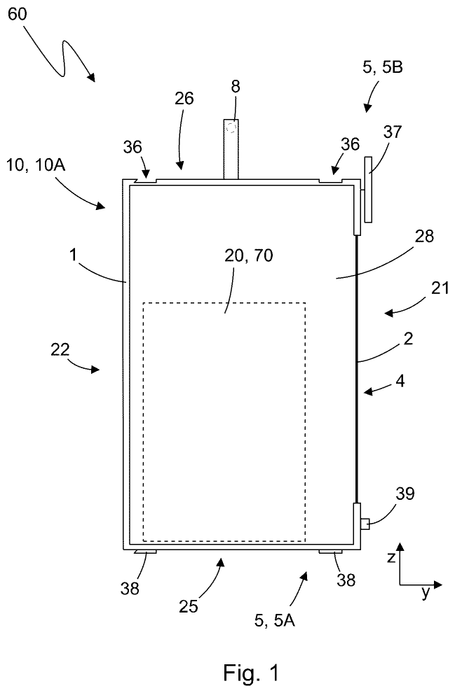

FIG. 1 a schematic lateral view of a transport arrangement,

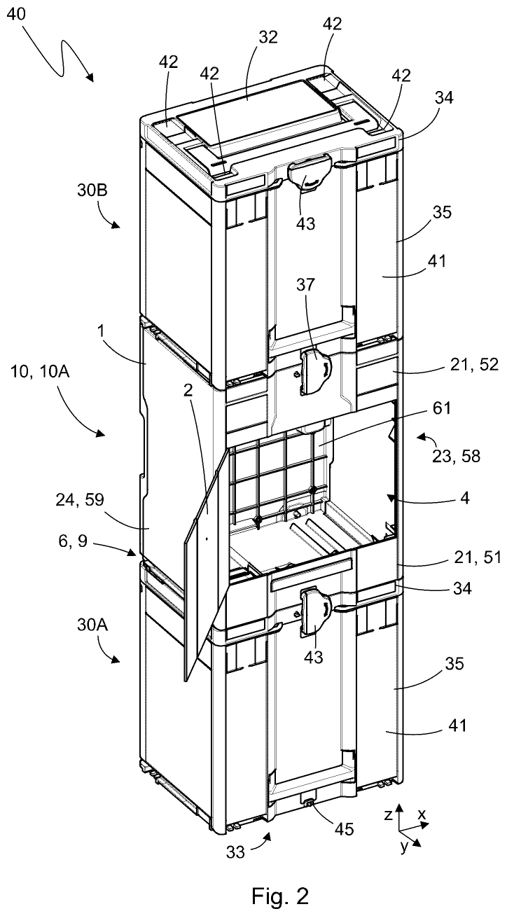

FIG. 2 a perspective view of a stack arrangement with a transport box according to a first variant,

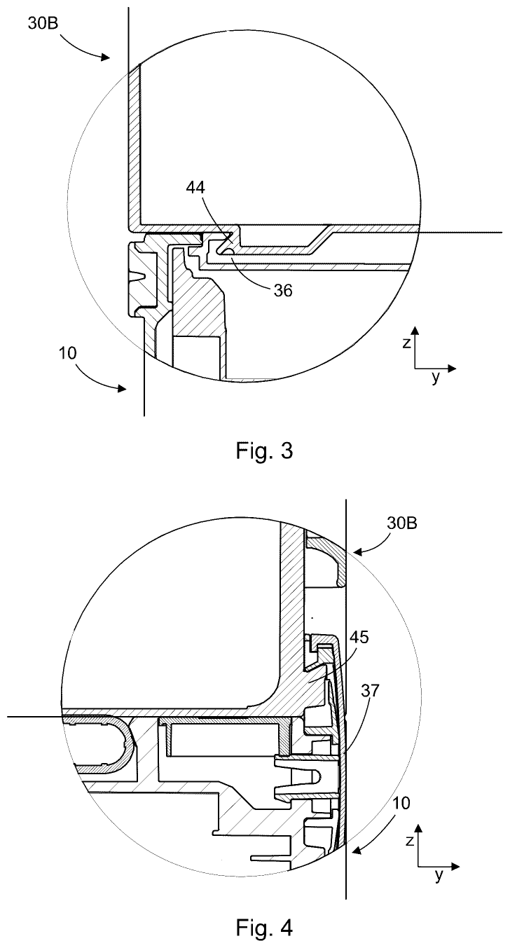

FIG. 3 a sectioned representation of an upper coupling recess of a coupling interface,

FIG. 4 a sectioned representation of a rotary bar of the coupling interface,

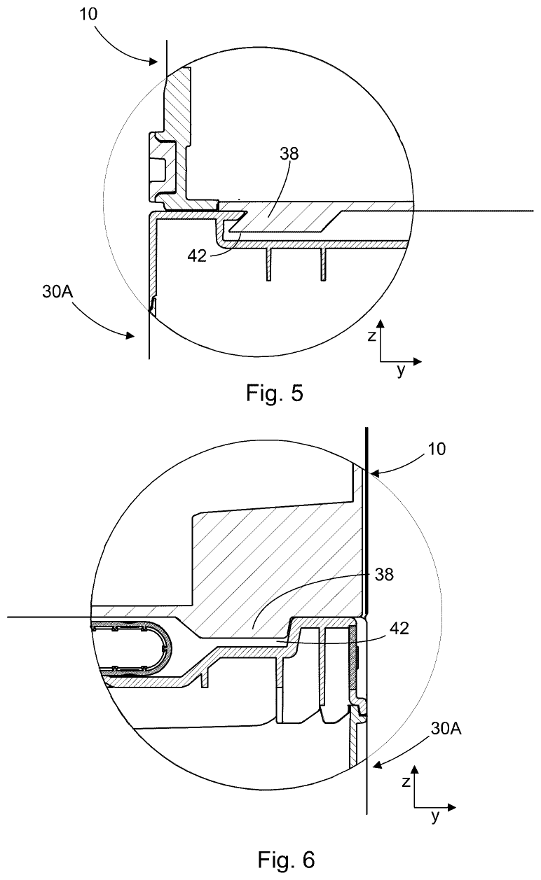

FIG. 5 a sectioned representation of a lower coupling projection of the coupling interface,

FIG. 6 a sectioned representation of a lower coupling projection of the coupling interface,

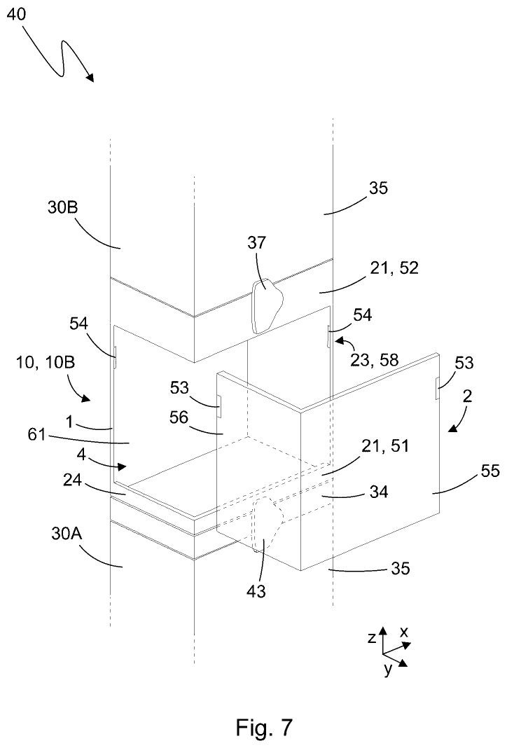

FIG. 7 a perspective view of a stack arrangement with a transport box according to a second variant,

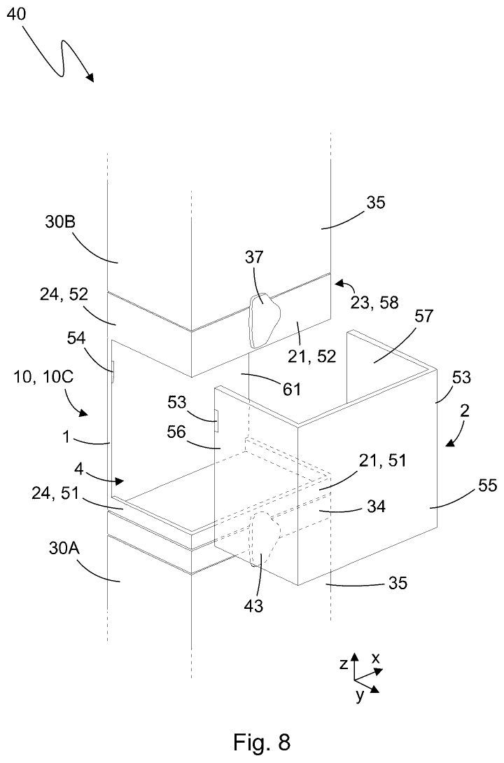

FIG. 8 a perspective view of a stack arrangement with a transport box according to a third variant,

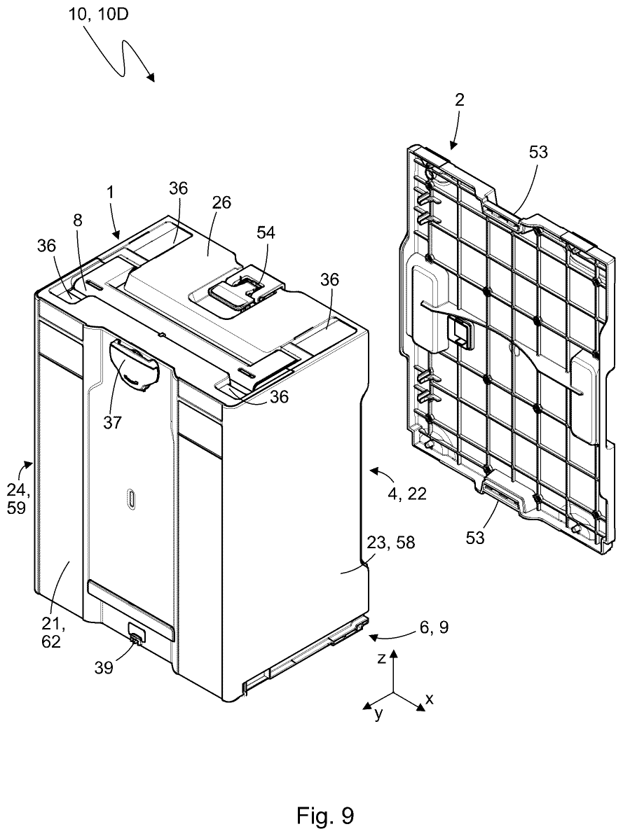

FIG. 9 a perspective view of a transport box according to a fourth variant,

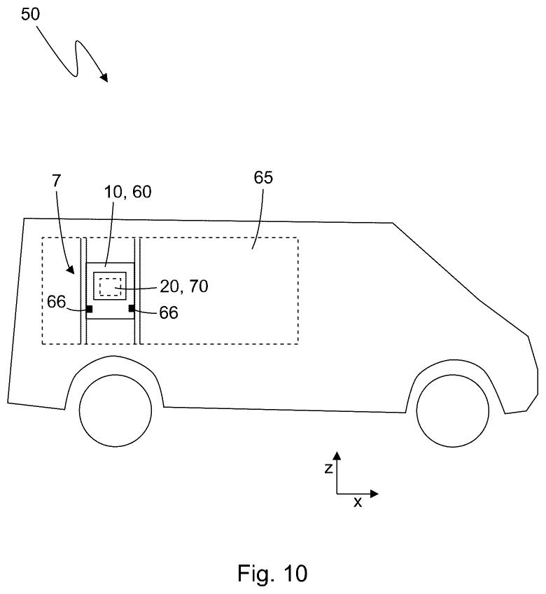

FIG. 10 a schematic representation of a motor vehicle.

The directions x-direction, y-direction and z-direction which are drawn in the figures and are aligned orthogonally to one another are referred to hereinafter. The x-direction and the y-direction are horizontal directions and the z-direction is a vertical direction.

FIG. 1 shows a transport box 10 with an interior 28 for accommodating a transport item 20, in particular a tool, preferably an electrical tool 70.

By way of example, the transport box 10 and/or the interior 28 is designed in a cuboid manner. Expediently, all outer sides of the transport box 10 are closed. The transport box 10 in particular is dimensioned in a manner such that it can be carried by a single person. Preferably, the horizontal dimensions of the transport box 10 are less than 50 cm times 50 cm.

By way of example, the transport box 10 comprises a wall structure 1 and a cover stricture 2 which is attached to the wall structure 1. The transport box 10 further comprises one or more coupling sections which are movably mounted on the wall structure 1, by way of example a rotary bar 37 which is movably mounted on the wall structure 1.

The transport box 10 comprises a horizontally (by way of example normally to the positive z-direction) aligned transport box upper side 26, a horizontally (by way of example normally to the negative z-direction) aligned transport box lower side 25 and four vertically aligned transport box peripheral sides 21, 22, 23, 24 which extend vertically upwards from the transport box lower side to the transport box upper side. The transport box peripheral sides 21, 22, 23, 24 are each either formed by the wall structure 1 or by the cover structure 2, or are each formed by the wall structure 1 and the cover structure 2. At least one transport box peripheral side is formed by the wall structure 1, in particular only by the wall structure 1.

The transport box peripheral sides 21, 22, 23, 24 in particular comprise a front transport box peripheral side 21 which by way of example is aligned normally to the positive y-direction, a rear transport box peripheral side 22 which by way of example is aligned normally to the negative y-direction, a first lateral transport box peripheral side 23 which by way of example is aligned normally to the positive x-direction, and/or a second lateral transport box peripheral side 24 which by way of example is aligned normally to the negative x-direction.

The wall structure 1 expediently surrounds the interior 28. The wall structure 1 by way of example comprises an upper wall which provides the transport box upper side 26 and/or a lower wall which provides the transport box lower side 25. The wall structure 1 further comprises one or more vertical wall sections which each provide a respective transport box peripheral side 21, 22, 23, 24 (partly or completely). The wall structure 1 comprises at least one vertical wall section which extends from the lower wall to the upper wall. The wall structure 1 is preferably designed in a single-piece manner. For example, the wall structure 1 is an injection moulded part.

An access opening 4 to the interior 28 is arranged in the wall structure 1 on one of the transport box peripheral sides 21, 22, 23, 24—by way of example on the front transport box peripheral side. Preferably, the access opening 4 with its opening plane is aligned vertically, by way of example normally to the positive y-direction.

The transport box 10 comprises the cover structure 2 which is arranged on the wall structure 1 and which can be selectively brought into a closure position or an open position. In the closure position, the cover structure 2 closes the access opening 4, in particular in a complete manner. In the open position, the cover structure 2 releases the access opening 4 to the interior 28.

FIG. 1 shows the cover structure 2 in the closure position and FIG. 2 shows the cover structure 2 in the open position. In the open position, a user can grip from the outside through the access opening 4 into the interior 28, in particular in order to remove the transport item 20 through the access opening 4 out of the interior 28—and herewith out of the transport box 10. In the closure position the transport item 20 cannot be removed through the access opening 4 out of the transport box 10.

The cover structure 2 is expediently designed as one piece and is for example an injection moulded part.

The transport box 10 further comprises a coupling interface 5 for the releasable, vertically tension-proof coupling to an upper system box 30B which can be placed upon the transport box upper side 26 and to a lower system box 30B which is positionable below the transport box lower side, in order with the upper system box 30A and the lower system box 30B to form a vertical stack.

The cover structure 2 can be brought into the open position without a change of the coupling interface 5 and/or without movement of the transport box upper side 26 and/or without movement of the transport box lower side 25, in which open position the cover structure 2 releases the access opening 4 to the interior 28.

The access opening 4 and/or the cover structure 2 (in the closure position) expediently extends over at least 70%, at least 80% or at least 90% of the horizontal extension, in particular of the x-extension, of that transport box peripheral side, by way of example the front transport box peripheral side 21, at which the access opening 4 is present and/or of the horizontal extension, in particular of the x-extension, of the transport box 10.

The access opening 4 and/or the cover structure 2 (in the closure position) expediently extends over at least 50%, at least 70% or at least 90% of the vertical extension, in particular of the z-extension, of that transport box peripheral side, by way of example the front transport box peripheral side, on which the access opening 4 is present and/or of the horizontal extension, in particular of the x-extension, of the transport box 10.

The transport box 10 by way of example comprises a carrier grip 8, with which the transport box 10 can be carried. An exemplary design of the transport box 10 with the carrier grip 8 is shown in FIG. 9. The carrier grip 8 is preferably arranged on the transport box upper side 26, in particular at the outside. The carrier grip 8 by way of example is designed in a bow-shaped manner. Expediently, the carrier grip 8 is designed in a foldable manner and can be selectively brought into a folded-in position or a folded-out position.

Preferably, a transport arrangement 60 is provided, said transport arrangement comprising the transport box 10 as well as an electrical tool 70, in particular a long-neck grinder, which is arranged in the transport box 10. The electrical tool 70 can be removed from the transport box 10 via the access opening 4, in the open position of the cover structure 2.

Hereinafter, the coupling interface 5 is to be dealt with in more detail.

The transport box 10 can be coupled onto a system box 30 via the coupling interface 5. In particular, a releasable, vertically tension-proof coupling between the transport box 10 and at least one system box 30 can be created via the coupling interface 5, in order with the at least one system box 30 to form a vertical stack.

The vertically tension-proof coupling is a coupling which transmits force in the vertical direction. In particular, the vertically tension-proof coupling is a coupling which transmits a vertical tensile force. For example, the vertically tension-proof coupling is a coupling which functions as a fixed bearing and/or transmits forces in all spatial directions. In a case, in which the transport box 10 is placed onto the system box 30, the vertically tension-proof coupling effects the co-lifting of the system box 30 on lifting the transport box 10. In a case in which the stem box 30 is placed upon the transport box 10 and is coupled to this in a vertically tension-proof manner, the vertically tension-proof coupling effects the co-lifting of the transport box 10 by way of lifting the system box 30.

In particular, the releasable, vertically tension-proof coupling in particular is a coupling which can be released without a tool.

In particular, the system box 10 is a transport box. The system box 30 comprises a system box coupling interface with which the system box can be coupled in a releasable, vertically tension-proof manner to a compatible system box—thus in particular to a further system box of the same system—in order to form a vertical stack. The system box 30 is cuboid. The system box 30 by way of example comprises an (in particular cuboid) system box lower part 35 and a system box lid 34 which is attached to the system box lower part 35 and in particular is placed upon this. The upper part of the system box lid 34 provides a system box upper side 32. The lower side of the system box lower part 35 provide a system box lower side 33.

The coupling interface 5 by way of example comprises a lower coupling interface 5A, and/or an upper coupling interface 5B. Preferably the coupling interface 5 consists of the lower coupling interface 5A and the upper coupling interface 5B. With the lower coupling interface 5A, the transport box 10 can be coupled in a releasable and vertically tension-proof manner onto a lower system box 30A, upon which the transport box 10 is placed. With the upper coupling interface 5B, the transport box 10 can be coupled in a releasable and vertically tension-proof manner onto an upper system box 30B which is placed upon the transport box 10.

The lower coupling interface 5A is arranged on the transport box lower side 25, in particular partly or completely. The upper coupling interface 5B is arranged on the transport box upper side 26, in particular partly or completely.

The coupling interface 5 expediently comprises several coupling sections. The coupling sections expediently comprise one or more stationary coupling sections, for example one or more coupling recesses and/or one or more coupling projections. Expediently, the coupling interface 5 further comprises at least one (by way of example precisely one) movably mounted coupling section, for example a coupling bar. In particular, the coupling bar is designed as a rotary bar 37, by way of example as a T-shaped rotary bar.

The upper coupling interface 5A by way of example comprises several coupling sections which in particular are arranged on the transport box upper side 26 and/or on the front transport box peripheral side 21. By way of example, the upper coupling sections comprise coupling recesses 36 which in particular are arranged on the transport box upper side 26. Expediently, the upper coupling sections comprise a rotary bar 37 which in particular is arranged on the front transport box peripheral side 21. The coupling interface preferably comprises the rotary bar 37 which is arranged on the same transport box peripheral side as the access opening 4.

The lower coupling interface 5A by way of example comprises several lower coupling sections which in particular are arranged on the transport box lower side 25 and/or the front transport box peripheral side 21. By way of example, the lower coupling sections comprise lower coupling projections 38 which in particular are arranged on the transport box lower side 25 and are designed for example as stand feet. Expediently, the lower coupling sections comprise a front coupling projection 39 which in particular is arranged on the front transport box peripheral side 21.

The coupling interface 5 is expediently designed in manner such that it can be coupled to an identical coupling interface; in particular the lower coupling sections 5A of the coupling interface 5 can be coupled to upper coupling sections 5A of an identical coupling interface. For example, the lower coupling projections 38 of the coupling interface 5 can be brought into engagement with coupling recesses of an identical coupling interface and/or the front coupling projection 39 can be brought into engagement with a rotary bar of the identical coupling interface.

FIG. 2 shows a stack arrangement 40. The stack arrangement 40 is an exemplary design of the vertical stack. The stack arrangement 40 comprises the transport box 10 as well as a lower system box 30A and/or an upper system box 30B. The system boxes 30A, 30B are examples of the system box 30; the explanations which relate to the system box 30 also each expediently apply to the upper system box 30A and/or the lower system box 30B. The transport box 10 in particular can be the transport box 10A, 10B, 10C or 10D which is explained hereinafter.

The upper system box 30B is placed upon the transport box upper side 26. The transport box 10 is coupled to the upper system box 30B in a releasable and vertically tension-proof manner via the coupling interface 5. The transport box 10 with its transport box lower side 25 is placed upon the lower system box 30A. The transport box 10 is coupled to the lower system box 30A in a releasable and vertically tension-proof manner via the coupling interface 5. The cover structure 2 can be brought into the open position without for this moving the upper system box 30B and/or the lower system box 30A.

Expediently, the coupling interface 5 comprises the lower coupling interface 5A which provides a lower releasable and vertically tension-proof coupling to the lower system box 30A. Preferably, the coupling interface 5 comprises the upper coupling interface 5B which provides an upper, releasable and vertically tension-proof coupling to the upper system box 30B.

The vertical stack extends vertically upwards in a vertical stack direction. The stack direction is the positive z-direction. The base surface of the vertical stack is expediently equal to the x-y dimensions of the transport box 10. In particular, the transport box 10 and the lower system box 30A and/or the upper system box 30B each have the same horizontal dimensions.

The system box 30, in particular the lower system box 30A and/or the upper system box 30B comprises a system box coupling interface with an upper system box coupling interface with which the system box 30 can be coupled onto the lower coupling interface 5A, and a lower system box coupling interface with which the system box can be coupled to the upper coupling interface 5B. The system box coupling interface is expediently designed in accordance with the coupling interface 5.

The upper system box coupling interface by way of example comprises several upper system box coupling sections which in particular are arranged on the system box upper side 32 and/or a system box front side 41. By way of example, the upper system box coupling sections comprise system box coupling recesses 42 which in particular are arranged on the system box upper side 32. Expediently, the upper system box coupling sections comprise a system box rotary bar 43 which in particular is arranged on the system box front side 41.

The lower system box coupling interface by way of example comprises several lower system box coupling sections which in particular are arranged on the system box lower side 33 and/or on the system box front side 41. By way of example, the lower system box coupling sections comprise lower system box coupling projections 44 which in particular are arranged on the system box lower side 33 and are designed for example as stand feet. Expediently, the lower system box coupling sections comprise a front system box coupling projection 45 which in particular is arranged on the system box front side 41.

The lower system box 30A and/or the upper system box 30B comprises a respective system box transport box lower part 35, upon which a respective system box lid 34 is placed, as well as a respective system box rotary bar 43 which is arranged on the respective system box lid 34 and contributes to the respective releasable, vertically tension-proof coupling.

FIGS. 4 to 7 show details of the releasable, vertically tension-proof coupling. In FIG. 4 one can see how a lower system box coupling projection 44 of the upper system box 30B engages into a coupling recess 36 of the transport box 10. In FIG. 5 one can see how a front system box coupling projection 43 is engaged with a rotary bar 37 of the transport box 10. In FIGS. 6 and 7, one can see how lower coupling projections 38 of the transport box 10 engage into system box coupling recesses 42 of the lower system box 30A.

Different variants of the transport box 10 are discussed hereinafter.

The transport box 10 which is shown in FIGS. 1 and 2 is also to be denoted as a transport box 10A according to a first variant. The details which relate to the transport box 10 preferably also apply to the transport box 10A.

By way of example, the access opening 4 is designed in a rectangular manner and with its rectangular plane is aligned vertically—thus normally to a horizontal direction, by way of example normally to the positive y-direction.

The access opening 4 is preferably only present on one transport box peripheral side. The access opening 4 is preferably present on the front transport box peripheral side 21, in particular exclusively on the front transport box peripheral side 21.

The cover structure 2 is preferably plate-like. In the closure position, the plate plane of the cover structure 2 is expediently aligned vertically—thus normally to a horizontal direction, by way of example normally to the positive y-direction. In the closure position, the outer contour of the cover structure 2 is preferably a rectangle which lies in an x-z-plane.

The cover structure 2 is preferably designed as a flap, in particular as a door. Expediently, the cover structure 2 is movably, in particular pivotably mounted on the wall structure 1, preferably about a pivot axis which runs in the z-direction or about a pivot axis which runs horizontally (in particular in the x-direction). For example, the transport box 10 comprises a pivot bearing with which the cover structure 2 is pivotably mounted on the wall structure 1, preferably about a pivot axis which runs in the z-direction or a pivot axis which runs horizontally (in particular in the x-direction). Expediently, the pivot axis runs through an in particular horizontal edge region of the cover structure 2 and/or of the transport box peripheral side, in particular of the front transport box peripheral side 21. The horizontal edge region is expediently that region in which the front transport box peripheral side 21 meets the lateral transport box peripheral side, in particular the second lateral transport box peripheral side 24. Expediently, the cover structure 2 can be brought from the closure position into the open position and/or from the open position into the closure position by way of pivoting about the pivot axis.

By way of example, the wall structure 1 comprises a lower wall section 51 and/or an upper wall section 52 which are arranged on the front transport box peripheral side 21 and/or are aligned vertically. The lower wall section 51 extends vertically upwards from the transport box lower side 25, in particular the lower wall of the wall structure 1, up to the lower end of the access opening 4. The upper wall section 52 extends vertically downwards from the transport box upper side 26, in particular from the upper wall of the wall structure 1, down to the upper end of the access opening 4. By way of example, the lower wall section 51 and/or the upper wall section 52 are designed in a strip-like manner and/or are aligned normally to the positive y-direction. By way of example, the rotary bar 38 is arranged on the upper wall section 52 and/or the front coupling projection 39 is arranged on the lower wall section 51.

The wall structure 1 preferably comprises a first lateral wall section 58 which is aligned vertically, in particular normally to the positive x-direction, and expediently extends from the lower wall to the upper wall of the wall structure 1. Preferably, the wall structure 1 comprises a second lateral wall section 59 which is aligned vertically, in particular normally to the negative x-direction, and expediently extends from the lower wall to the upper wall of the wall structure 1. 1. Preferably the wall structure 1 comprises a rear wall section 61 which is aligned vertically, in particular normally to the negative y-direction, and expediently extends from the lower wall to the upper wall of the wall structure 1.

The transport box 10 which is shown in FIG. 7 is also to be denoted as a transport box 10B according to a second variant. The explanations which relate to the transport box 10 also preferably apply to the transport box 10B. The transport box 10B is preferably designed as the transport box 10A with the exception of differences which are explained hereinafter, so that the explanations with regard to this preferably also apply to the transport box 10B.

The cover structure 2 is preferably completely removable from the wall structure 1, in order to assume the open position and release the access opening 4.

Expediently, the cover structure 2 is designed as a lid (by way of example with regard to the second variant, third variant and/or fourth variant). The cover structure 2 in particular is not a drawer and/or not a part of a drawer. The cover structure 2 is expediently designed in a planar manner and/or preferably does not project into the interior 28. In particular, the cover structure (in a state in which it is attached to the wall structure 1 and closes the access opening, thus the closure position) projects into the interior 28 (in the negative y-direction) by less than 50% (or less than 30%) of the y-extension of the interior 28. Preferably (in a state of the cover structure 2 in which it is attached to the wall structure 1 and closes the access opening) each wall, in particular each cover wall, of the cover structure 2 represents an outer wall of the transport box.

By way of example, the cover structure 2 comprises cover structure fastening sections 53 and the wall structure 1 comprises transport box fastening sections 54, on which the cover structure 2 can be releasably fastened with the cover structure fastening sections 53, in order to assume the closure position.

By way of example, the access opening 4 extends over at least two, preferably precisely two transport box peripheral sides, by way of example the front transport box peripheral side 21 and the second lateral transport box peripheral side 24. The access opening 4 is arranged on the front transport box peripheral side 21 and on the second lateral transport box peripheral side 24 and in particular is a single, continuous access opening. The access opening 4 preferably extends in the x-direction over at least 80% of the x-extension of the transport box 10 and/or in the y-direction over at least 80% of the y-extension of the transport box 10.

By way of example, the cover structure 2 comprises a first cover wall 55 and a second cover wall 6 which is aligned orthogonally to the first cover wall. In a horizontal section, the cover structure 2 has an L-shaped course. In the closure position, the first cover wall 55 is aligned normally to the positive y-direction and covers the part of the access opening 4 which is arranged on the front transport box peripheral side 21, in particular in a complete manner. In the closure position, the second cover wall 56 is aligned normally to the negative x-direction and covers the part of the access opening 4 which is arranged on the second lateral transport box peripheral side 24, in particular in a complete manner.

By way of example, the wall structure 1 comprises the lower wall section 51 and/or the upper wall section 52, which with the exception of the differences explained hereinafter are expediently designed as explained beforehand in the context of the transport box 10A.

The lower wall section 51 and/or the upper wall section 52 each extend over the front transport box peripheral side 21 and the second lateral transport box peripheral side 24. The lower wall section 51 and/or the upper wall section 52 expediently each have an L-shaped course in a horizontal section.

The wall structure 1 preferably comprises the first lateral wall section 58 which is aligned vertically, in particular normally to the positive x-direction, and expediently extends from the lower wall to the upper wall of the wall structure 1. The wall structure 1 preferably comprises the rear wall section 61 which is aligned vertically, in particular normally to the negative y-direction, and expediently extends from the lower wall to the upper wall of the wall structure 1.

The transport box 10 which is shown in FIG. 8 is also to be denoted as a transport box 10C according to a third variant. The explanations which relate to the transport box 10 preferably also apply to the transport box 10C. The transport box 10C is preferably designed as the transport box 10B with the exception of the differences explained hereinafter, so that explanations with regard to this also apply to the transport box 10C.

By way of example, the access opening 4 extends over at least three, preferably precisely three transport box peripheral sides, by way of example the front transport box peripheral side 21, the first lateral transport box peripheral side 23 and the second lateral transport box peripheral side 24. The access opening 4 is arranged on the front transport box peripheral side 21, on the first lateral transport box peripheral side 23 and on the second lateral transport box peripheral side 24 and in particular is a single, continuous access opening. The access opening 4 preferably extends in the x-direction over the entire x-extension of the transport box 10 and/or in the y-direction over at least 80% of the y-extension of the transport box 10, in particular on the first lateral transport box peripheral side 23 as well as on the second lateral transport box peripheral side 24.

By way of example, the cover structure 2 comprises a first cover wall 55 and a second cover wall 56 which is aligned orthogonally to the first cover wall 55. The cover structure 2 further comprises a third cover wall 57 which is aligned parallel to the second cover wall 56. In an x-y section, the cover structure 22 has a U-shaped course. In the closure position, the first cover wall 55 is aligned normally to the positive y-direction and covers the part of the access opening 4 which is arranged on the front transport box peripheral side 21, in particular in a complete manner. In the closure position the second cover wall 56 is aligned normally to the negative x-direction and covers the part of the access opening 4 which is arranged on the second lateral transport box peripheral side 24, in particular in a complete manner. In the closure position, the third cover wall 57 is aligned normally to the positive x-direction and covers the part of the access opening 4 which is arranged on the first lateral transport box peripheral side 23, in particular in a complete manner.

By way of example, the wall structure 1 comprises the lower wall section 51 and/or the upper wall section 52, which with the exception of the differences which are explained hereinafter are expediently designed as explained beforehand in the context of the transport box 10A.

The lower wall section 51 and/or the upper wall section 52 each extend over the front transport box peripheral side 21, the first lateral transport box peripheral side 23 and the second lateral transport box peripheral side 24. The lower wall section 51 and/or the upper wall section 52 expediently has a U-shaped course in a horizontal section.

Preferably, the wall structure 1 comprises the rear wall section 61 which is aligned vertically, in particular normally to the negative y-direction, and expediently extends from the lower wall to the upper wall of the wall structure 1.

The transport box 10 which is shown in FIG. 9 is also to be denoted as a transport box 10D according to a fourth variant. The explanations which relate to the transport box 10 also preferably apply to the transport box 10D.

By way of example, the cover structure 2 is a removable rear wall of the transport box 10. The wall structure 1 by way of example is designed in a cuboid manner with an (in particular completely) open rear wall structure side. The rear wall structure side is arranged on the rear transport box peripheral side 22. The open rear wall structure side forms the access opening 4. The access opening 4 extends from the lower wall of the wall structure 1 to the upper wall of the wall structure 1. The access opening 4 is aligned vertically with its opening plane and in particular has a rectangular outer contour.

The cover structure 2 by way of example is designed in a plate-like manner. The cover structure 2 is designed in a rectangular manner. In the closure position, the cover structure 2 extends from the lower wall of the wall structure 1 to the upper wall of the wall structure 1. In the closure position, the cover structure is aligned normally to the negative y-direction.

By way of example, the cover structure 2 comprises cover structure fastening sections 53 and the wall structure 1 comprises transport box fastening sections 54, to which the cover structure 2 with the cover structure fastening sections 53 can be releasably fastened, in order to assume the closure position.

The wall structure 1 preferably comprises a first lateral wall section 58 which is aligned vertically, in particular normally to the positive x-direction, and expediently extends from the lower wall to the upper wall of the wall structure. Preferably, the wall structure 1 comprises a second lateral wall section 59 which is aligned vertically, in particular normally to the negative x-direction, and expediently extends from the lower wall to the upper wall of the wall structure 1. The wall structure 1 preferably comprises a front wall section 62 which is aligned vertically, in particular normally to the positive y-direction, and expediently extends from the lower wall to the upper wall of the wall structure 1.

The transport box 10 preferably comprises a fastening interface 6 for the releasable fastening of the transport box 10 in a vehicle stowage device 7. An exemplary design of the fastening interface 6 is shown in FIG. 2 and in FIG. 9, and an exemplary design of the vehicle stowage device 7 is shown in FIG. 10.

The fastening interface 6 expediently comprises fastening sections 9 which in particular are designed as fastening recesses and by way of example are arranged on the first lateral transport box peripheral side 23 and/or on the second transport box peripheral side 24, in particular on the wall structure 1. The fastening sections 9 (which by way of example are designed as fastening recesses) are expediently designed in an elongate manner and are aligned with their longitudinal axis in the y-direction. The fastening sections 9 in particular are designed as fastening grooves.

FIG. 10 shows a vehicle 50 which comprises stowage space 65 in which a vehicle stowage device 7 is arranged. The vehicle stowage device 7 by way of example is designed as a shelf. The vehicle stowage device 7 preferably comprises stowage device fastening sections 66 which for example are designed as a pull-out element and/or in the manner of a rail. The transport box 10 is releasably fastened to the vehicle stowage device 7. For example, the transport box 10 with its fastening interface 6 is releasably fastened on the stowage device fastening sections 66. The transport box 10 is for example the previously discussed transport box 10A, 10B, 10C or 10D. By way of example, the transport item 20, in particular the electrical tool 70 is arranged in the transport box 10. The transport box 10 and the transport item 20, in particular the electrical tool 70 expediently form a transport arrangement 60. The transport box 10 in the state in which it is attached to the vehicle stowage device 7 is aligned in a manner such that the access opening 4 faces the interior of the storage space 65, so that in this state a user can bring the cover structure 2 into the open position and can remove the transport item 20, in particular the electrical tool 70 out of the interior 28 of the transport box 10 without removing the transport box 10 from the vehicle stowage device 7.

Optionally, the transport arrangement 60 or the stack arrangement 40 is releasably fastened to the vehicle stowage device 7, in particular instead of the transport box 10.

The transport box 10 in particular can be operated with a method which comprises the step: bringing the cover structure 2 into the open position without a change of the coupling interface 5 and/or without moving the transport box upper side 26 and/or the transport box lower side 25.

For example, a user places the transport box 10 onto the lower system box 30A and couples the transport box 10 with the lower coupling interface 5A onto the lower system box 30A. Expediently, the user places an upper system box 30B onto the transport box 10 and couples the transport box 10 with the upper coupling interface 5B onto the upper system box 30B. The user can then bring the cover structure 2 from the closure position into the open position, in order to obtain access to the interior 28 without the user having to move the upper system box 30B and/or the lower system box 30A.

Optionally, the user releases the transport box 10 from the upper system box 30B and/or the lower system box 30A. Preferably, the user transports the transport box 10 into the storage space 65 and fastens the transport box 10 on the vehicle stowage device 7.

Optionally, at least one wall (for example the transport box upper side, the transport box lower side, the transport box peripheral side) of the transport box is designed as a grille or comprises a grille. In particular, at least one wall of the wall structure and/or at least one wall (in particular a cover wall) of the cover structure are designed as a grille or comprise a grille.

1-17. (canceled)

18. A transport box with an interior for accommodating a transport item, as well as with a wall structure which provides a horizontally aligned transport box upper side and a horizontally aligned transport box lower side, wherein the transport box comprises a coupling interface for the releasable, vertically tension-proof coupling to an upper system box which can be placed onto the transport box upper side and to a lower system box which can be positioned below the transport box lower side, in order to form, with the upper system box and the lower system box, a vertical stack, wherein the transport box comprises an access opening to the interior, said access opening being arranged on a vertically aligned transport box peripheral side, and wherein the transport box comprises a cover structure which is attached to the wall structure and which in a closure position closes the access opening, wherein the cover structure can be brought into an open position in which the cover structure releases the access opening to the interior, without a change of the coupling interface and/or without a movement of the transport box upper side and/or of the transport box lower side.

19. The transport box according to claim 18, wherein the access opening is aligned vertically with its opening plane.

20. The transport box according to claim 18, wherein the cover structure is plate-like.

21. The transport box according to claim 18, wherein the cover structure is designed as a flap.

22. The transport box according to claim 18, wherein the cover structure can be completely removed from the wall structure in order to assume the open position and to release the access opening.

23. The transport box according to claim 18, wherein the access opening extends over at least two transport box peripheral sides.

24. The transport box according to claim 18, wherein the access opening extends over at least three transport box peripheral sides.

25. The transport box according to claim 18, wherein the cover structure comprises a first cover wall and a second cover wall which is aligned orthogonally to the first cover wall.

26. The transport box according to claim 25, wherein the cover structure comprises a third cover wall which is aligned parallel to the second cover wall.

27. The transport box according to claim 18, wherein the coupling interface comprises a rotary bar which is arranged on the same transport box peripheral side as the access opening.

28. The transport box according to claim 18, wherein the cover structure is a removable rear wall of the transport box.

29. The transport box according to claim 18, further comprising a fastening interface for the releasable fastening of the transport box in a vehicle stowage device.

30. A stack arrangement, comprising a transport box according to claim 18, the upper system box and the lower system box, wherein the upper system box is placed onto the transport box upper side and the transport box is coupled via the coupling interface to the upper system box in a releasable and vertically tension-proof manner, and wherein the transport box with its transport box lower side is placed onto the lower system box and the transport box is coupled via the coupling interface to the lower system box in a releasable and vertically tension-proof manner, and wherein the cover structure can be brought into the open position without moving the upper system box and/or the lower system box.

31. The stack arrangement according to claim 30, wherein the lower system box and/or the upper system box comprises a respective system box lower part, onto which a respective system box lid is placed, as well as a respective system box rotary bar which is arranged on the respective system box lid and contributes to the respective releasable, vertically tension-proof coupling.

32. The transport arrangement comprising a transport box according to claim 18, as well as an electrical tool which is arranged in the transport box and which via the access opening can be removed from the transport box in the open position of the cover structure.

33. The transport arrangement of claim 32, wherein the electrical tool is a long-neck grinder,

34. A motor vehicle comprising a storage space, in which a vehicle stowage device is arranged, on which vehicle stowage device a transport box according to claim 18 is releasably fastened.

35. A motor vehicle comprising a storage space, in which a vehicle stowage device is arranged, on which vehicle stowage device a stack arrangement according to claim 30 is releasably fastened.

36. A method for operating a transport box according to claim 18, comprising the step: bringing the cover structure into the open position without changing the coupling interface and/or without moving the transport box upper side and/or the transport box lower side.
